(19) United States
(12) Patent Application Publication
(10) Pub. No.: US 2014/0337148 A1
(43) Pub. Date: Nov. 13, 2014

(54) METHOD AND APPARATUS FOR PROVIDING AN APPLICATION MARKETPLACE

(71) Applicants: Rajeswari Kannan, Bangalore (IN); Pranav Mishra, Bangalore (IN)

(72) Inventors: Rajeswari Kannan, Bangalore (IN); Pranav Mishra, Bangalore (IN)

(73) Assignee: Nokia Corporation, Espoo (FI)

(21) Appl. No.: 14/348,053

(22) PCT Filed: Aug. 22, 2012
(86) PCT No.: PCT/FI2012/050801

§ 371 Date: Jul. 10, 2014

(30) Foreign Application Priority Data
Oct. 4, 2011 (IN) 3446/CHE/2011

(51) Int. Cl. G06Q 30/06

(52) U.S. Cl. CPC G06Q 30/0601
USPC 705/14.73; 705/26.1

(57) ABSTRACT

An approach is provided for providing an application marketplace where applications are marketed, purchased, and operationally linked, that has a framework for developers to contribute product, share revenue and communicate with one another. The approach involves determining one or more unique identifiers for one or more applications sold by way of one or more application stores. The approach further involves causing, at least in part, an application of the one or more applications to publish, by way of the application store, one or more of configuration information, input parameters, output parameters and a unique identifier for the application. The approach also involves causing, at least in part, one or more other applications to communicate with the application based on the unique identifier, configuration information and the input parameters for the application. The approach additionally involves causing, at least in part, a transmission of the output parameters to the one or more other applications.

### BACKGROUND

Service providers and device manufacturers are continually challenged to deliver value and convenience to consumers by, for example, providing compelling network services. Such compelling services may include providing an application marketplace where applications are purchased and a framework for developers to contribute product, share revenue and communicate with one another.

### SOME EXAMPLE EMBODIMENTS

Therefore, there is a need for an approach for providing an application marketplace where applications are marketed, purchased, and operationally linked, that has a framework for developers to contribute product, share revenue and communicate with one another.

According to one embodiment, a method comprises determining one or more unique identifiers for one or more applications sold by way of one or more application stores. The method also comprises causing, at least in part, an application of the one or more applications to publish, by way of the application store, one or more of configuration information, input parameters, output parameters and a unique identifier for the application. The method further comprises causing, at least in part, one or more other applications to communicate with the application based on the unique identifier, configuration information and the input parameters for the application. The method additionally comprises causing, at least in part, a transmission of the output parameters to the one or more other applications.

According to another embodiment, an apparatus comprises at least one processor, and at least one memory including computer program code for one or more computer programs, the at least one memory and the computer program code configured to, with the at least one processor, cause, at least in part, the apparatus to determine one or more unique identifiers for one or more applications sold by way of one or more application stores. The apparatus is also caused to cause, at least in part, an application of the one or more applications to publish, by way of the application store, one or more of configuration information, input parameters, output parameters and a unique identifier for the application. The apparatus is further caused to cause, at least in part, one or more other applications to communicate with the application based on the unique identifier, configuration information and the input parameters for the application. The apparatus is additionally caused to cause, at least in part, a transmission of the output parameters to the one or more other applications.

According to another embodiment, a computer-readable storage medium carries one or more sequences of one or more instructions which, when executed by one or more processors, cause, at least in part, an apparatus to determine one or more unique identifiers for one or more applications sold by way of one or more application stores. The apparatus is also caused to cause, at least in part, an application of the one or more applications to publish, by way of the application store, one or more of configuration information, input parameters, output parameters and a unique identifier for the application. The apparatus is further caused to cause, at least in part, one or more other applications to communicate with the application based on the unique identifier, configuration information and the input parameters for the application. The apparatus is additionally caused to cause, at least in part, a transmission of the output parameters to the one or more other applications.

According to another embodiment, an apparatus comprises means for determining one or more unique identifiers for one or more applications sold by way of one or more application stores. The apparatus also comprises means for causing, at least in part, an application of the one or more applications to publish, by way of the application store, one or more of configuration information, input parameters, output parameters and a unique identifier for the application. The apparatus further comprises means for causing, at least in part, one or more other applications to communicate with the application based on the unique identifier, configuration information and the input parameters for the application. The apparatus additionally comprises means for causing, at least in part, a transmission of the output parameters to the one or more other applications.

According to another embodiment, a method comprises transmitting information for a first application comprising information on one or more operationally linked applications. The method also comprises storing linkage information of the first application to the one or more operationally linked other applications.

According to another embodiment, an apparatus comprises at least one processor, and at least one memory including computer program code for one or more computer programs, the at least one memory and the computer program code configured to, with the at least one processor, cause, at least in part, the apparatus to transmit information for a first application comprising information on one or more operationally linked applications. The apparatus is also caused to store linkage information of the first application to the one or more operationally linked other applications.

According to another embodiment, a computer-readable storage medium carries one or more sequences of one or more instructions which, when executed by one or more processors, cause, at least in part, an apparatus to transmit information for a first application comprising information on one or more operationally linked applications. The apparatus is also caused to store linkage information of the first application to the one or more operationally linked other applications.

According to another embodiment, an apparatus comprises means for transmitting information for a first application comprising information on one or more operationally linked applications. The apparatus also comprises means for storing linkage information of the first application to the one or more operationally linked other applications.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-11, 23-37, 42-45, and 50-52.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an application marketplace where applications are marketed, purchased, and operationally linked, that has a framework for developers to contribute product, share revenue and communicate with one another, according to one example embodiment;

FIG. 2 is a diagram of the components of an application development platform, according to one example embodiment;

FIG. 3 is a flowchart of a process for providing an application marketplace where applications are marketed, purchased, and operationally linked, that has a framework for developers to contribute product, share revenue and communicate with one another, according to one example embodiment;

FIGS. 4A and 4B are diagrams of user interfaces utilized in the processes of FIG. 3, according to various example embodiments;

FIG. 5 is a diagram of a user interface utilized in the processes of FIG. 3, according to one example embodiment;

FIG. 6 is a diagram of a process for calculating revenue sharing, according to one example embodiment;

FIG. 7 is a diagram of hardware that can be used to implement an example embodiment of the invention;

FIG. 8 is a diagram of a chip set that can be used to implement an example embodiment of the invention; and

FIG. 9 is a diagram of a mobile terminal (e.g., handset) that can be used to implement an example embodiment of the invention.

### DESCRIPTION OF SOME EMBODIMENTS

Examples of a method, apparatus, and computer program for providing an application marketplace where applications are marketed, purchased, and operationally linked, that has a framework for developers to contribute product, share revenue and communicate with one another are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

An application marketplace is a network place at which applications may be made available for sharing and/or purchase. Conventionally, in a two sided network, the application marketplace is on one side of application development and a technology platform/device for developing applications is on another side. But, innovations and/or differentiation are also needed in the application marketplace to further develop available applications.

In conventional application marketplaces, there is no way for applications to communicate with one another, or share revenue between application developers. For example if a developer has a great idea for improving an existing application by way of a plugin, for example, the developer cannot contact the developers of the application through the application marketplace, plug the plugin to the application, and share revenue in symbiotic way.

From a consumer standpoint, conventional application marketplaces can be overwhelming because there are too many applications available for any person to comprehend. For example, if a consumer searches for an application to find friends near the consumer's location, there could be 3-4 applications available. But, the consumer only needs one of the applications to satisfy his needs, not all of them. How does the consumer choose? Consumers also do not want to piece together multiple smaller applications like a puzzle that all work together to satisfy his needs. For example, a consumer wants an application that improves a device's video capture experience. In some application marketplaces there is an application for video stabilization and another application to remove audio noise. As a consumer it's very difficult to use several different applications to solve minor problems.

There is a need to streamline application advancement in an efficient manner that promotes creativity and makes consumer lives easier by providing integrated solutions. Integrated solutions have an effect of reducing the population of repetitive applications in a marketplace, reducing the need for piecing smaller applications together to solve a larger problem, improving existing applications by incorporating additional features that otherwise would not have been available, and possibly reducing the overall cost for application usage for the consumer.

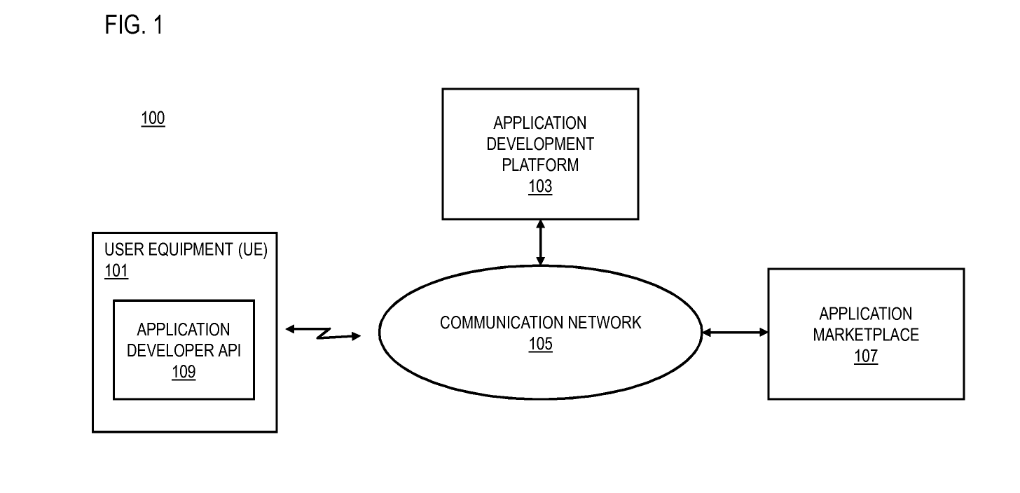

FIG. 1 is a diagram of a system capable of providing an application marketplace where applications are marketed, purchased, and operationally linked, that has a framework for developers to contribute product, share revenue and communicate with one another, according to one embodiment. Instead of re-inventing the wheel for each application, it is desirable to use the existing ecosystem of existing applications to build on top of the existing applications to enhance their performance. However, conventional application marketplaces do not provide a way for developers to collaborate to provide combined services such as collaborated and/or synergistic applications that can be built upon, added to, and/or utilize the features of existing applications, or promote revenue sharing among developers of collaborated and/or synergistic applications.

To address this problem, a system 100 of FIG. 1 introduces the capability to provide an application marketplace where applications are marketed, purchased, and operationally linked, that has a framework for developers to contribute product, share revenue and communicate with one another.. As shown in FIG. 1, the system 100 comprises a user equipment (UE) 101 having connectivity to an application development platform 103 and an application marketplace 107 via a communication network 105. The UE 101 has an application programming interface (API) for application developer 109 that facilitates development of applications, application plugins, application enhancements, advertising, referral linkages, organization of dependencies of one or more applications, plugins and/or enhancements on pre-existing applications available at the application marketplace 107, and the like.

The system 100 is a two-sided network that increases developer demand and enables a new ecosystem for developers. On the developer side of ecosystem, where applications communicate to each other by way of the application development platform 103, developers share revenue from each other in a symbiotic fashion. The application marketplace 107 enables these benefits. In some example embodiments, the application development platform 103 and application marketplace 107 are parts or function of a same system, apparatus, server and/or service provider.

To facilitate the enhancement of applications, the application developer API 109 communicates with the application development platform 103 to enable features like application to application communication or dynamic linking, registration in order to dynamically load and unload plugins or given a dynamically linked library (DLL), can be linked to the feature chain. The application development platform 103 may be a message processing unit (MPU) that passes messages between applications that are available in the application marketplace 107. The application development platform 103 and/or the application marketplace 107 assign a unique ID for each application that is available at the application marketplace 107. This unique ID for the applications is made available to all developers by way of the application development platform 103 and/or the application marketplace 107. The unique ID is a means for identifying a particular application among many possible available applications at the application marketplace 107 so that developers and/or consumers can find the application in the application marketplace 107. The application development platform 103, in this embodiment, knows all the applications that are available at the application marketplace 107 and their unique ID's. Any application that is available at the application marketplace 107 can be operationally linked together and communicate with another application using the application development platform 103.

For example, a first application (A1) may publish any of its API's, configuration, input parameters, output parameters, unique ID so that the information can be used by any developer wanting to enhance the available application. Then, if a second application (A2) wants to communicate with the first application A1, an appropriate message may be sent to the first application A1 with configurations and input parameters. The application development platform 103 invokes the first application A1 (if it is not already running) and sends it the configuration and input parameters. Accordingly, once the first application A1 gives back the appropriate output parameter, the output parameter is conveyed to the second application A2.

At this point, the second application A2 can provide any dependency linkage it has to the first application A1. This dependency linkage gets registered with the application development platform 103. The first application A1 can modify its application to list all the applications dependent upon it. The developer of application A1 may be given the option of promoting the second application A2 at the application marketplace 107, for example under a banner on the application marketplace 107. So, if a consumer visits the application marketplace 107 to download and/or use the first application A1, he may also be provided a recommendation for the second application A2. Also, in one or more embodiments, a developer of the first application A1 may be provided a mechanism to promote the first and second applications A1 and A2 to the existing customer base of the application marketplace 107 and/or any of the first or second applications A1 and A2.

In one or more embodiments, and for example purposes, applications that may be operationally linked and/or communicate to one another may be games, content publishing applications (e.g., pictures, music, video, books, stories, wallpapers, magazines etc), feeds (social, news, etc.), media applications (e.g., video player, book reader, image capture applications, etc.), web based applications, runtime applications (e.g., Java/flash based applications, etc.), among others, or any combination thereof

For example, in a case where imaging apps communicate with one another, a first developer A has a concept of suggesting names to a face (App A1). The first developer able to sell the App A on the application marketplace 107. But, consumers complain that an algorithm of App A1 does not work well for blurry images. Accordingly, a second developer B has an application (App A2) that reduces blur, and developer B has published his message API's for this. Developer A may modify App A1 to improve upon the blurry image problem by operationally linking the App A1 and App A2 together. The application development platform 103 and/or the application market place may check if App A2 is installed on the device. If yes, a message may be sent from App A1 to App A2 to deblur a particular image (msg:A2:input:imageSource=abcd.jpg, for example). App A2 may process the image and return back an output message (msg:A1:output:imageSource=dcba.jpg, for example) for App A1 to use for providing a deblurred image. From the consumer perspective, the problem of blurry images is solved by installing both the applications, App A1 and App A2 that work synergistically together based on the operational linking and messaging and knowing each application's API's, configuration, input parameters, output parameters, and/or unique ID. The outcome is a win for all parties involved. Developer B is happy because his application will sell more often along with A1, and developer A is happy because his customers are happy.

In another example in which the application is a game A1, a first developer A has an idea for adding or changing levels for the game. Developer A makes an application A2 based on his idea. The application development platform 103 checks whether the application A1 is installed on a UE 101. If the application A1 is not installed, the application development platform 103, by way of the application developer API 109, asks the developer A to install the application A1 on the UE 101. Once installed, the application A1 communicates with the application A2 through the application development platform 103. An input message (msg:A1:inputmap=abcd) is shared, and the application A1 can define the format for these input maps. Because the applications A1 and A2 are communicating openly, the Developer A and a consumer that installed both applications A1 and A2 can play with the enhanced levels seamlessly.

In another example in which the application is a book reader application, a developer A has an idea for a popular book reader application. Developer A publishes the necessary API's and a sample application for publishers. Publishers may publish in their content using this sample application. Developer A can recommend this application on his own webpage, and/or on the application marketplace 107. Then, for every download, of this content, the publisher may get money from symbiotic sales of the published content. The application, in this example, may display any recommended applications by the developer for an existing database of users.

In another example, when applications A1 and A2 are already installed in the UE 101 and the apps are already linked by the developer of A1, they can communicate without accessing the platform 103 on the server or the application market place 107. The UE 101 may facilitate in-device communication between the apps in the UE 101. In a case where application A2 is not installed on the UE 101, information of availability (e.g. a link/icon information) of A2 may be presented on a user interface of UE 101 as a part of application A1, for example. In order to know or find the existence of application A2, the UE 101 communicates with the application development platform 103 and/or the application marketplace 107.

In one or more example embodiments, revenue sharing for sales and/or advertising of any application available on the application marketplace 107 between developers of applications that are symbiotic and/or operationally linked may be facilitated by the application development platform 103. For example, a small developer of an application for an unpopular brand can't compete with a more popular application as a separate application available at the application marketplace 107. The reason being that a consumer probably won't be willing to pay for and download a random plugin for an unpopular brand. Accordingly, any revenue that might be generated for the small developer would probably be very low amount.

So, the small developer may use the system 100 to collaborate with the more popular brand application to incorporate the small developer's idea to augment consumer interest in the popular application. Now, since the small developer can see the details for popular application by way of the application development platform 103 and learn the appropriate input and output ports where the small developer's plugin can be added, or alternatively send the small developer's DLL/plugin (not code) to the developer of the popular application for a specified platform, the small developer may pay a lump sum to popular application developer for allowing the small developer to add his code/idea into their immensely popular brand application, for example. Then, by way of collaborative agreement, or a setting made by the application marketplace 107 as a default revenue sharing agreement between developers that use the application development platform 103 and the application marketplace 107 for selling any symbiotic and/or operationally linked applications, the two developers may choose an amount for every download of the application where the added feature is used (analytics collected by the application marketplace 107, for example) such that the small developer gets X % revenue sharing and/or the application marketplace 107 may get Y % revenue sharing for facilitating the symbiotic relationship.

To facilitate the revenue sharing, one key feature/enabler is the information of established links, e.g. the operational links, between applications. In order to do revenue sharing the application development platform 103 and/or the application marketplace 107 has to know the number of the established links between applications, not only number of downloaded applications in user devices as the applications can be downloaded, but also those applications that are used independently. Establishment of links can happen automatically on the application development platform 103 and/or the application marketplace 107 when a user has been given information on linked applications that is used to initiate downloading any of the linked applications. Also already downloaded applications in the UE 101 can be linked using the information on the linked applications received from the application development platform 103. In this case, established links information may be sent back to the application development platform 103 by the UE 101. In addition, UE 101's can even provide real usage information for the linked application when used using the established link. This usage information could be used for making any revenue sharing between developers even more accurate. For example, if an application A1 accounts for most of the usage and application A2 accounts for very little, while application A2 is still being used, any revenue sharing percentages agreed upon by the requisite developers and/or the system 100 could further be based on the actual usage to further define any revenue sharing amount for revenues earned based on the usage of the applications A1 and A2.

By way of example, the communication network 105 of system 100 includes one or more networks such as a data network, a wireless network, a telephony network, or any combination thereof It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

The UE 101 is any type of user terminal, fixed terminal, mobile terminal, or portable terminal including a mobile handset, station, unit, device, mobile phone, mobile communication device, multimedia computer, multimedia tablet, Internet node, communicator, desktop computer, laptop computer, personal computer (PC), notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof It is also contemplated that the UE 101 can support any type of interface to the user (such as “wearable” circuitry, etc.). The UE 101 may be embedded or separable attached in any kind of vehicle, for example a car, truck, boat or airplane.

By way of example, the UE 101, application development platform 103 and application marketplace 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

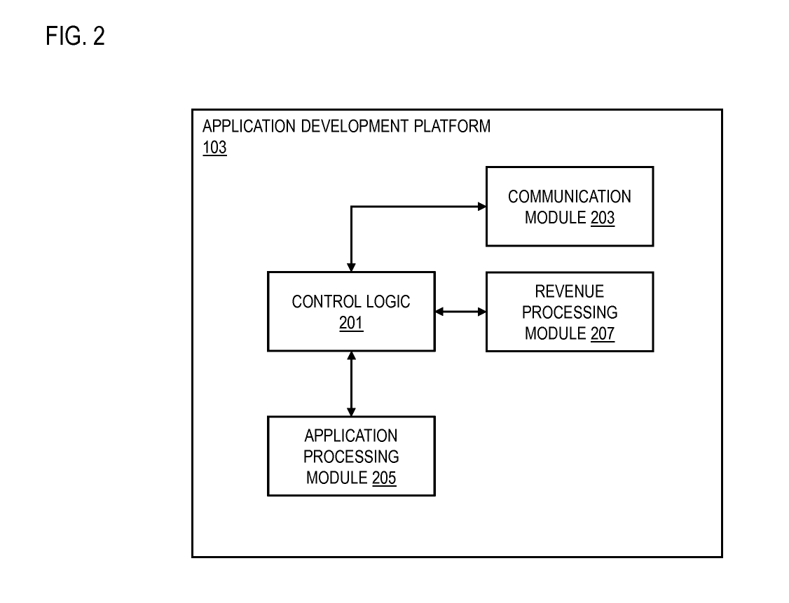

FIG. 2 is a diagram of the components of the application development platform 103, according to one embodiment. By way of example, the application development platform 103 includes one or more components and/or functions for providing an application marketplace where applications are marketed, purchased, and operationally linked, that has a framework for developers to contribute product, share revenue and communicate with one another. It is contemplated that the functions of these components may be combined in one or more components or performed by other components of equivalent functionality. In this embodiment, the application development platform includes a control logic 201, a communication module 203, an application processing module 205 and a revenue processing module 207. In another example embodiment, the application development platform 103 is included in the application marketplace 107.

The application development platform 103 facilitates communication and/or collaboration between applications and/or developers of applications that are available on the application marketplace 107 and or could be added to, or used to enhance applications that are available on the application marketplace 107. The control logic 201 receives a request to develop an enhancement to an application available at the application marketplace 107, collaborate with a developer of an application available at the application marketplace 107, operationally link one or more applications, and/or promote and/or share revenue for sales of an application or an associated application by way of the communication module 203 that communicates with the application developer API 109 that is associated with the UE 101.

The application processing module 205, in response to an instruction generated by the control logic 201 in response to the request may establish a communication session such as a discussion board, direct communication, SMS, email, MMS, etc. between the one or more applications and/or a developer using the developer API 109 and a developer of an application available at the application marketplace 107. The communication session may relate to a development of one or more plugins, for example, created by the developer using the developer API 109 for the application that is available at the application marketplace 107. The communication session may not be limited to only one application at a time, and may be used to collaborate regarding any number of applications and between any number of developers at any given time.

The application processing module 205 may also determine one or more identifiers such as the unique ID discussed above for any of the applications available at the application marketplace 107 and/or any of the newly developed applications or enhancements such as a plugin developed by the developer using the application developer API 109. In response to the request, the application processing module 205 may also route data and/or one or more messages among the applications, the plugins and/or enhancements based on the one or more identifiers.

Upon determining the identifiers, the application processing module 205 may publish the one or more identifiers by way of the application marketplace 107 to the one or more applications, to any of the developers, i.e. the developer using the developer API 109 and/or the developer of the application available at the application marketplace 107, or any other developers interested in enhancing the application available at the application marketplace 107. The determined and published information could further include, as discussed above, configuration information, one or more input parameters, one or more output parameters, one or more API's, or a combination thereof associated with the one or more applications, the one or more plugins, or a combination thereof.

The application processing module 205 also determines if any of the applications available on the application marketplace 107 and/or the plugins or enhancements are resident on the UE 101, for example, and may using this information or not determine one or more dependency linkages, e.g. operational linkages, associated with the one or more applications and one or more plugins. Based on the determined dependency linkages, the application processing module 205 may generate a dependency linkage list for storage at the application marketplace 107 and/or at the application development platform 103 from which revenue sharing can be based. Any dependency linkage list may be shared with the revenue processing module 207 for basing any revenue sharing calculations.

The revenue processing module 207 receives information regarding any dependency linkages between any of the application and causes a co-promotion of the one or more applications, the one or more plugins, or a combination thereof based, at least in part, on the one or more dependency linkages, the one or more respective dependency lists, or a combination thereof.

The revenue processing module 207 also determines cost information associated with a cost of the application and/or the plugin at the application marketplace 107, and/or any usage costs associated with the applications, for example on the UE 101 and from that determines revenue information for the one or more applications, the one or more plugins, The revenue processing module 207 may determine particular revenue sharing percentages based on one or more dependency linkages, the one or more respective dependency lists, or a combination thereof, as well as any determined weighting information associated with the one or more applications, the one or more plugins, or a combination thereof based, at least in part, on the one or more dependency linkages, the one or more respective dependency lists, or a combination thereof. For example, the weighting information could be a percentage of usage, or an importance factor, or a percentage of the amount of an effect that the plugin has on the operation of the one or more applications, or any agreed upon amount of revenue sharing such as a percentage of sales or generated cash flow agreed upon between parties or set as a default by the application marketplace 107. Revenue may also be collected from any other means for example, but not limited to collected advertising revenue relating to the one or more applications, the one or more plugins, a referral of the one or more applications and/or the one or more plugins, from one application to another by way of a link or message suggestion or banner, for example on the application marketplace 107, or any other means to promote an associated application or plugin.

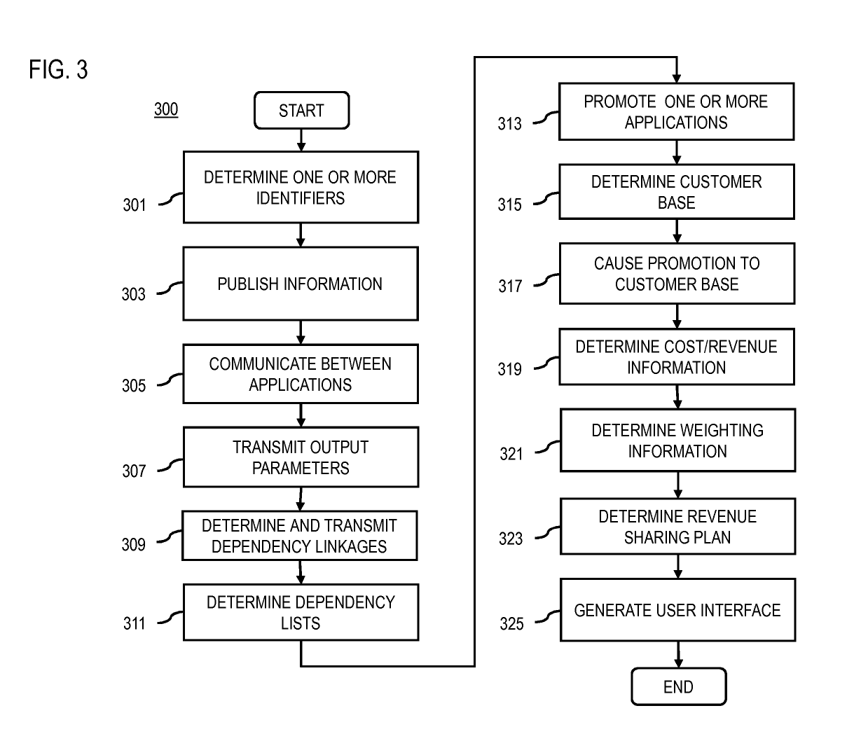

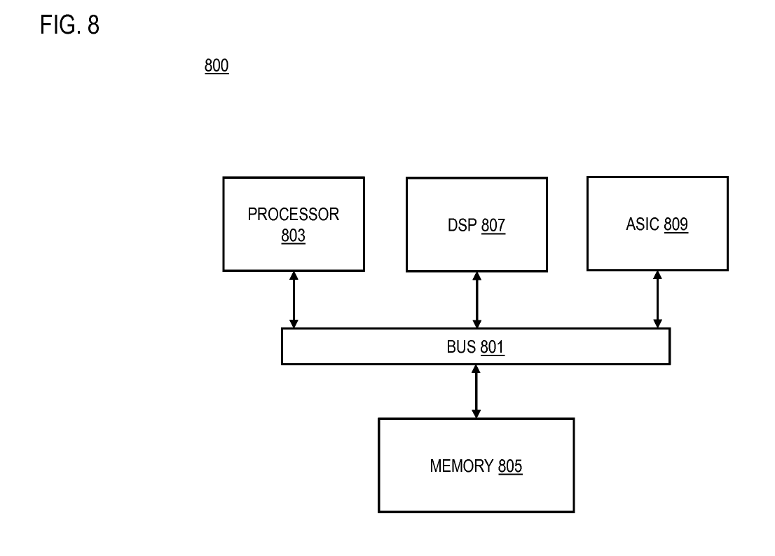

FIG. 3 is a flowchart of a process for providing an application marketplace where applications are marketed, purchased, and operationally linked, that has a framework for developers to contribute product, share revenue and communicate with one another, according to one embodiment. In one embodiment, the application development platform 103 performs the process 300 and is implemented in, for instance, a chip set including a processor and a memory as shown in FIG. 8. In step 301, application development platform 103 determines one or more unique identifiers for one or more applications sold by way of one or more application stores. Then, in step 303, the application development platform 103 causes at least in part, an application of the one or more applications to publish, by way of the application store, one or more of configuration information, input parameters, output parameters and a unique identifier for the application. The process continues to step 305 in which the application development platform 103 causes, at least in part, one or more other applications to communicate with the application based on the unique identifier, configuration information and the input parameters for the application.

In step 307, the application development platform 103 causes, at least in part, a transmission of the output parameters to the one or more other applications. Then, in step 309, the application development platform 103 causes, at least in part, at least one of the one or more other applications to send one or more determined dependency linkages between any of the one or more other applications and the application to the application.

The process continues to step 311 in which the application development platform 103 causes, at least in part, the application to modify one or more dependency lists of dependent applications so as to change the one or more dependency linkages of any of the one or more other applications on the application. The application development platform 103 also collects and stores information for applications that are downloaded and have defined dependency linkages. This information is used for determining revenue sharing in step 323, discussed below. Next, in step 313, the application development platform 103 cause, at least in part, provision of an option to promote at least one of the one or more other applications based on the one or more determined dependency linkages with the application. Then, in step 315, the application development platform causes, at least in part, causing, at least in part, a determination of a customer base of the application.

The process continues to step 317 in which the application development platform 103 causes, at least in part, a direct promotion of at least one of the one or more other applications to the determined customer base of the application based, at least in part, on the determined dependency linkage. Next, in step 319, the application development platform 103 causes, at least in part, at least one determination of cost information, revenue information, or a combination thereof for the one or more applications, the one or more other applications, or a combination thereof based, at least in part, on the one or more dependency linkages, the one or more respective dependency lists, or a combination thereof Then, in step 321, the application development platform 103 causes, at least in part, at least one determination of weighting information associated with the one or more applications, the one or more other applications, or a combination thereof based, at least in part, on the one or more dependency linkages, the one or more respective dependency lists, or a combination thereof.

The process continues to step 323 in which the application development platform 103 causes, at least in part, at least one determination of a revenue sharing plan among a first developer, at least one second developer, or a combination thereof based, at least in part, on the weighting information. The revenue sharing plan, as discussed above, is further based, at least in part, on one of (1) collected advertising revenue relating to the one or more applications, the one or more other applications, or a combination thereof; (2) a referral of the one or more applications, the one or more other applications, or a combination thereof; or (3) a combination thereof Further, the referral is based, at least in part, on a promotion of at least one of the one or more applications, the one or more other applications, or a combination thereof in at least another one of the one or more applications, the one or more other applications, or a combination thereof.

Then, in step 325, the application development platform 103 causes, at least in part, generation of a user interface configured to display the application store to one or more of a consumer and a developer based, at least in part, on log-in credentials. The log-in credentials enable access to the published configuration information, input parameters, output parameters and unique identifier for the application. For example, as discussed in more detail below, a consumer may have access for viewing and/or purchasing/downloading applications, but a developer, based on his log-in credentials may have access to another interface in which the developer may interface with other developers and/or enhance the available one or more applications in the application marketplace 107 by way of the application developer API 109.

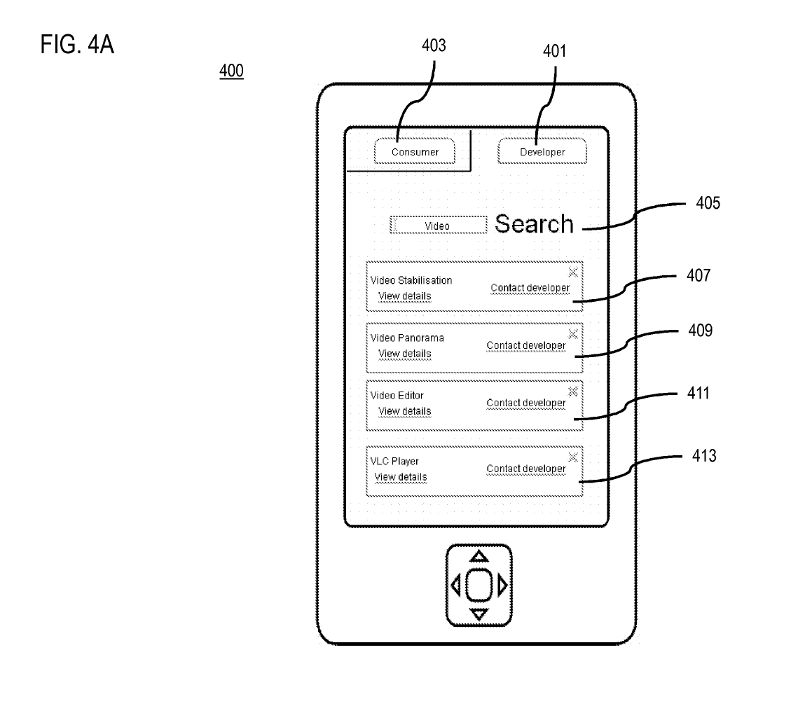

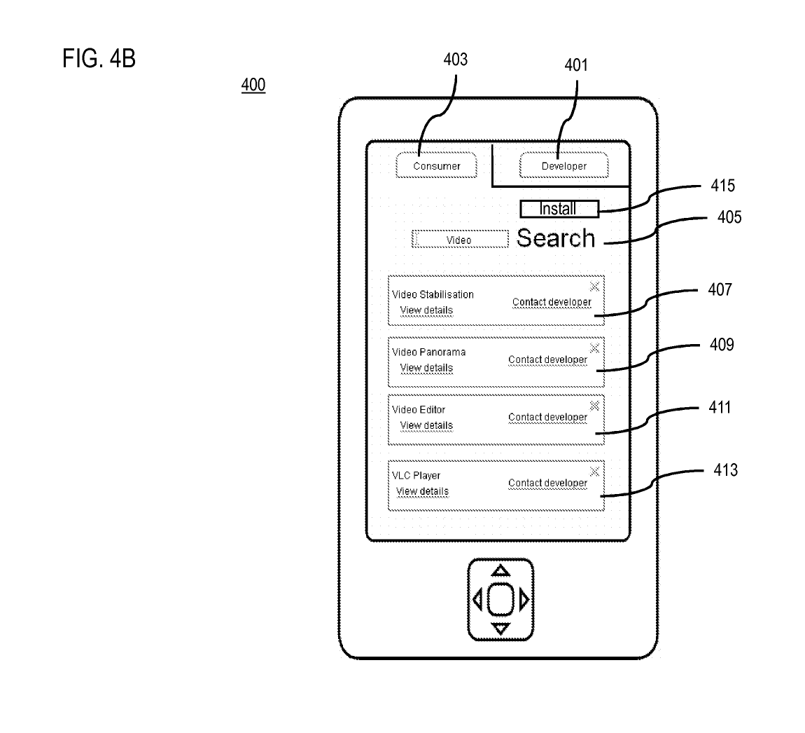

FIGS. 4A and 4B are diagrams of a user interface 400 utilized in the processes of FIG. 3, according to various embodiments. As illustrated in FIG. 4A, the user interface 400 may be associated with the application developer API 109 and optionally has a developer tab 401 and a consumer tab 403. The developer tab 401 enables a developer to communicate with various application developers of applications available on the application marketplace 107 discussed above. The consumer tab 403 enables a consumer to purchase and/or download applications available at the application marketplace 107.

With regard to the developer tab 401, the developer tab 401 for the application developer API 109 is optionally available if a user having a developer log-in and password for the application marketplace 107 logs in. Otherwise, only the consumer tab 403 would be visible to a consumer that accesses the application marketplace 107 by way of the application developer API 109 or through another network access means such as a browser. The developer tab 401 has a search function 405 so that a developer can search for relevant or linked applications available at the application marketplace 107. The search may be any topic such as genre, brand name, keyword related to the application, or any of a preference such as a price, rating of applications, and/or most downloaded or most heavily advertised applications, for example. The developer tab 401 also features a list of application tabs 407-413 that are associated with applications related to a search query that uses the search function 405. The linked application tabs 407-413 may be selectable, and may have selectable features such as a view details links. The view details link may a provide information about the unique ID, application functionality, various configurations, tags, available input and output ports for attaching plugins/DLLs, published calls for partnerships for joint development opportunities, the current cost of an application available at the application marketplace 107, a developer discussion board, consumer usage analytics data (with and without partnership associations), etc.

A developer may select any of the application tabs 407-413 to add a plugin/DLL to the selected application. The application tabs 407-413 may also have a contact developer link for contacting a developer of the selected application directly. The application marketplace 107 may facilitate that the actual developer details are hidden based on privacy support preferences set by a developer that makes his application available at the application marketplace 107.

FIG. 4B illustrates the user interface 400 from the consumer perspective, i.e., a user that does not have a developer log-in, or a developer that uses the consumer tab 403 to purchase and/or download an application available at the application marketplace 107, the consumer tab 403 would have at least a list of applications that are either simply available, recommended, based on a genus, top applications, resultant of a search query, etc. The consumer tab 403 may also have the search function 405 and list, or have available, the price of various applications, ratings of applications, customer reviews. Essentially the consumer tab 403 offers the same features for finding and purchasing applications associated with application tabs 407-413 as the developer tab 401, but may not enable a consumer to develop applications or plugins, or have access to the details about various applications that are available by way of the developer tab 401, or to contact a developer of an application.

If a consumer decides to purchase and/or download an application that is available at the application marketplace 107 that a developer has made available alone, or the developer and/or other developers have provided additional plugin enhancements, the application marketplace 107 may feed the application development platform 103 with the unique ID of the applications which are needed. These needed applications may be considered connector applications. The application development platform 103 responds to the application marketplace 107 with a notice of what applications the application development platform 103 determines are already installed on the consumer's UE 101. The application development platform 103 may compute the cost for the application marketplace 107 of buying the selected application based upon the response. When a developer makes an application available at the application marketplace 107 and/or any plugins or enhancements to the application available, the developer can mark certain applications as optional, if they are not compulsory for the base application. The consumer tab 403 may illustrate that certain applications are optional for download and not necessary. Such an illustration may be made by a text indicator, and the consumer may be able to select which applications are to be downloaded and/or purchased by a check box or by removing the application from the list by clicking an “X” on a requisite application tab 407-413, for example. The consumer may click an install button 415 available on the consumer tab 403 and all the required applications not present on the consumer's UE 101, as well as any selected optional applications, will be installed on the consumer's UE 101.

The application that is installed and/or the consumer tab 403 may have a recommended applications section that is navigable by way of a view details link, or other tab available by way of the consumer tab 403 in which all the optional apps which user has not installed can be listed. The recommended applications section may also list applications that are using the current application as optional. This recommendation schema provides an additional revenue source for application developers by causing an increased number of downloaded applications from the application marketplace 107 simply because the recommended applications are more readily available for the consumer to download. A consumer can install and connect any application from this recommended section.

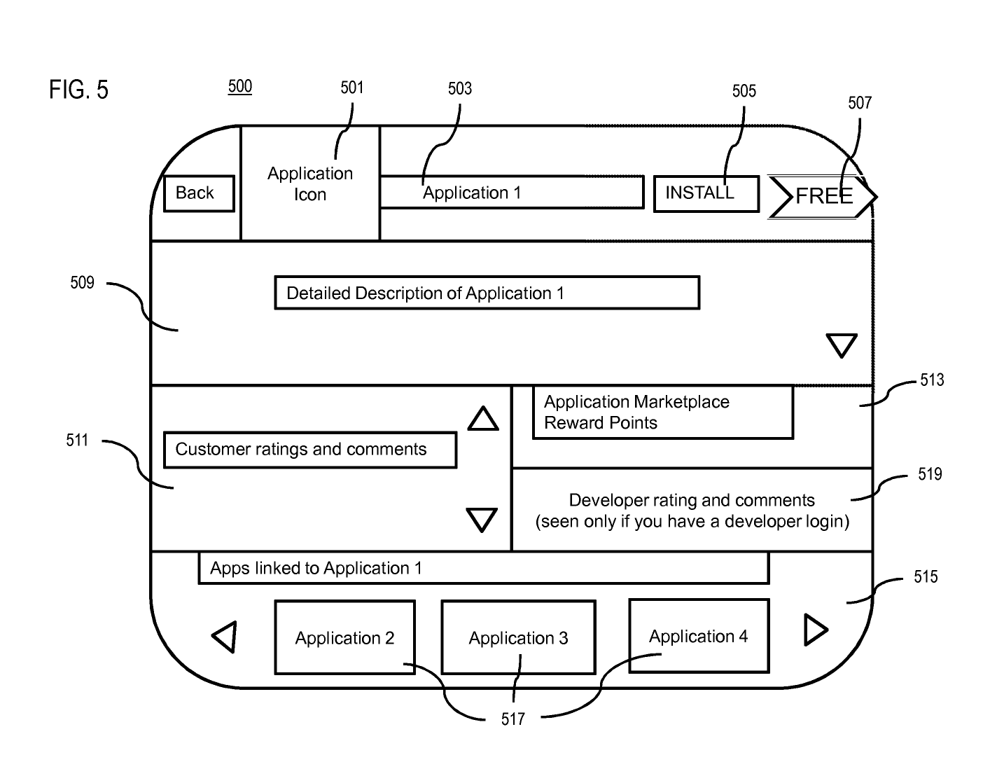

FIG. 5 is another example embodiment of a diagram of a user interface 500 utilized in the processes of FIG. 3. The user interface 500 illustrates a number of features such as, but not limited to, an application icon 501 that corresponds to a selected application in the application marketplace or available on the UE 101, an application title 503, an installation button 505, a cost indicator 507, and a description field 509 that describes the application. The user interface 500 also has a customer rating field 511 that allows a user to scroll through historical ratings and comments regarding the application, an application marketplace rewards section 513 that enumerates a number of reward points available based on usage and/or historical purchases that can be cashed in for future purchases. The user interface 500 also has a linked applications section 517 that illustrates a list of applications that are linked to the application illustrated as icon 501. From the list of applications, the user may select any of applications 517 for further purchase and/or association with the selected application 501. Depending on a user log-in, a user may have access to developer features such as those discussed above, or for viewing developer ratings 519.

The user interface 500, for example, may be used by a developer that has a developer log-in and access to all of the features discussed above as follows: a developer A makes a new photo application called Application 2. Developer A wants to use a map application for showing a location in which a photograph was taken. Developer A wants to use an existing map application for this purpose. Developer B has made a map application, Application 3 that has not yet been installed by a consumer. Developer A wants to link his photo application, Application 2, to the map application, and does so by the steps detailed above with regard to FIG. 3, for example.

When a consumer now downloads Application 1, the application marketplace 107 fetches details of all other applications making use of Application 1, in this case the applications are Application 2, Application 3 and Application 4 which all make use of API's linked to Application 1. If a user downloads any of Applications 2, 3, or 4, the application marketplace 107 percolates some money to a developer of Application 1.

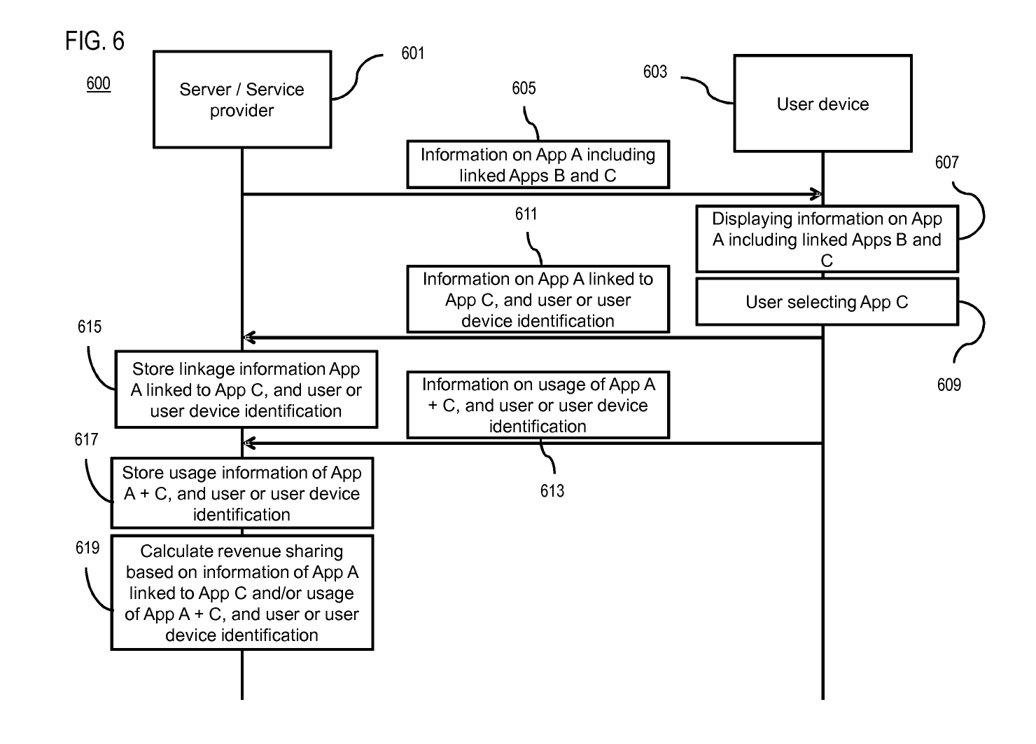

FIG. 6 illustrates a diagram of a process 600 that occurs between a server/service provider 601 and a user device 603. The server/service provider 601 sends information on a first application, application A to the user device 603 in step 605. The user device 603 displays information regarding application A that includes linked applications B and C. in step 607. Then, in step 609, a user may select an application, here it is application C, for example and the information regarding application A and its linkage to application C and any user and/or user device identification information is sent from the user device 603 to the server/service provider 601 in step 611. Also, in step 613, information regarding the usage of application A and C, and any user and/or user device identification information is sent to the server/service provider 601. In step 615, the server/service provider 601 may store the linkage information for applications A and C, and any user and/or user device identification information. In step 617, the server/service provider 601 may store the usage information for applications A and C, and any user and/ore user device identification information. The process continues to step 619 in which the server/service provider 601 calculates any revenue sharing based on information regarding the linkage between application A and application C, and/or usage of application A and application C, and any user or user device identification information.

The processes described herein for providing an application marketplace where applications are marketed, purchased, and operationally linked, that has a framework for developers to contribute product, share revenue and communicate with one another may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

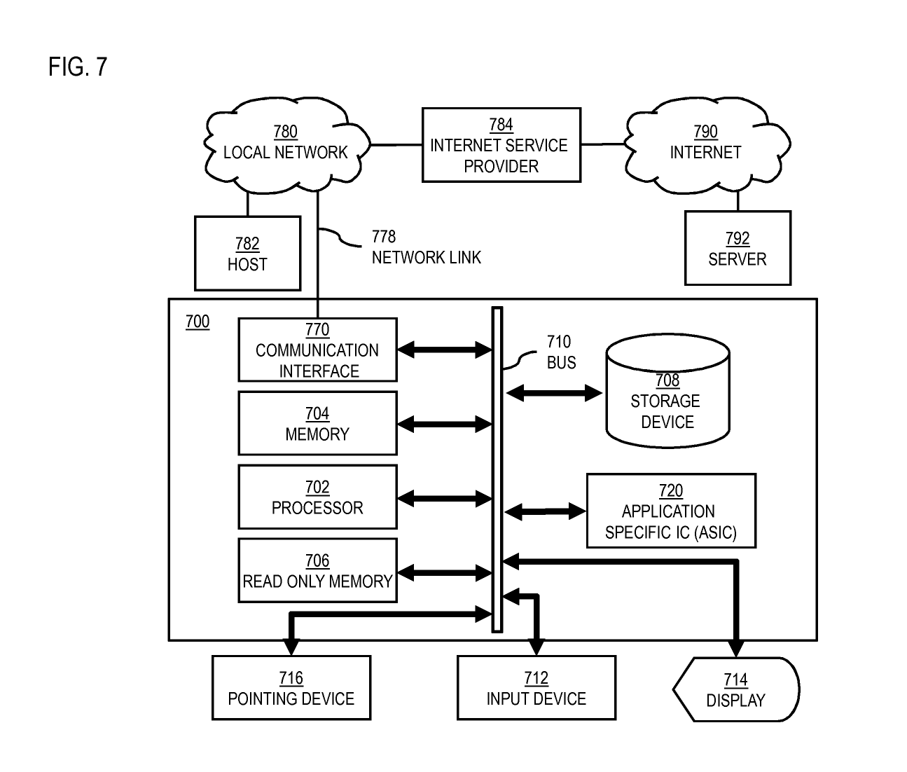

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide an application marketplace where applications are marketed, purchased, and operationally linked, that has a framework for developers to contribute product, share revenue and communicate with one another as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0,1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing an application marketplace where applications are marketed, purchased, and operationally linked, that has a framework for developers to contribute product, share revenue and communicate with one another.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to provide an application marketplace where applications are marketed, purchased, and operationally linked, that has a framework for developers to contribute product, share revenue and communicate with one another. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for providing an application marketplace where applications are marketed, purchased, and operationally linked, that has a framework for developers to contribute product, share revenue and communicate with one another. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing an application marketplace where applications are marketed, purchased, and operationally linked, that has a framework for developers to contribute product, share revenue and communicate with one another, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing an application marketplace where applications are marketed, purchased, and operationally linked, that has a framework for developers to contribute product, share revenue and communicate with one another to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide an application marketplace where applications are marketed, purchased, and operationally linked, that has a framework for developers to contribute product, share revenue and communicate with one another as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of providing an application marketplace where applications are marketed, purchased, and operationally linked, that has a framework for developers to contribute product, share revenue and communicate with one another.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide an application marketplace where applications are marketed, purchased, and operationally linked, that has a framework for developers to contribute product, share revenue and communicate with one another. The memory 805 also stores the data associated with or generated by the execution of the inventive steps.

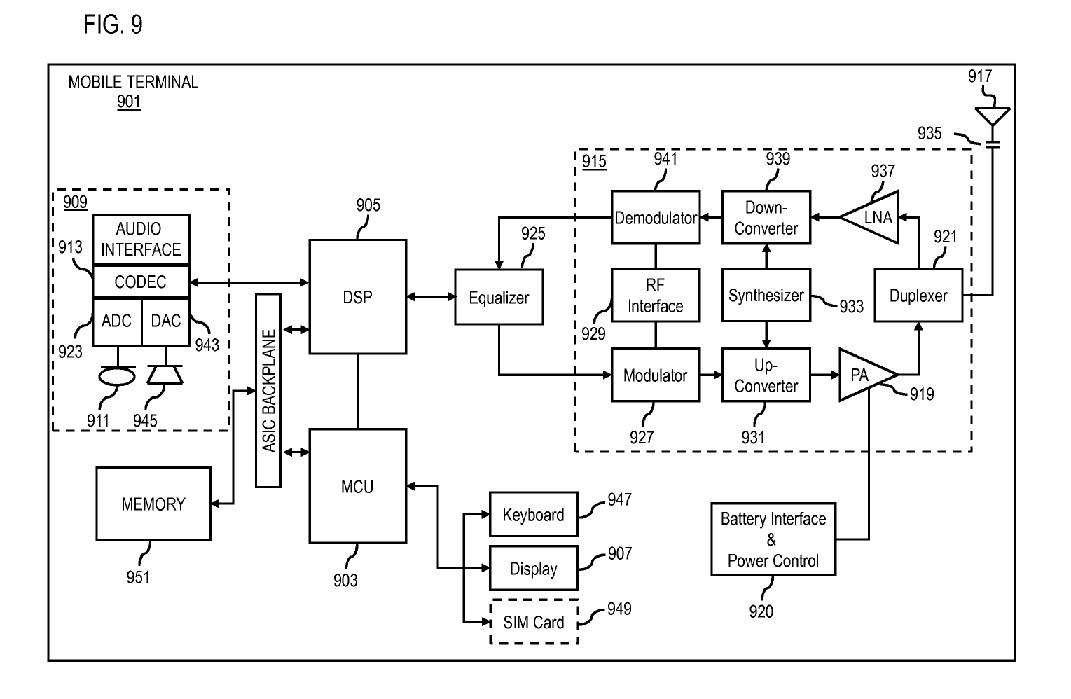

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of providing an application marketplace where applications are marketed, purchased, and operationally linked, that has a framework for developers to contribute product, share revenue and communicate with one another. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing an application marketplace where applications are marketed, purchased, and operationally linked, that has a framework for developers to contribute product, share revenue and communicate with one another. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide an application marketplace where applications are marketed, purchased, and operationally linked, that has a framework for developers to contribute product, share revenue and communicate with one another. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-53. (canceled)

54. An apparatus comprising:
at least one processor; and
at least one memory including computer program code for one or more programs,
the at least one memory and the computer program code configured to, with the at least one processor, cause the apparatus to perform at least the following,
determine one or more unique identifiers for one or more applications sold by way of one or more application stores;
cause, at least in part, an application of the one or more applications to publish, by way of the application store, one or more of configuration information, input parameters, output parameters and a unique identifier for the application;
cause, at least in part, one or more other applications to communicate with the application based on the unique identifier, configuration information and the input parameters for the application; and
cause, at least in part, a transmission of the output parameters to the one or more other applications.

55. An apparatus of claim 54, wherein the apparatus is further caused to:
cause, at least in part, at least one of the one or more other applications to send one or more determined dependency linkages between any of the one or more other applications and the application to the application.

56. An apparatus of claim 55, wherein the apparatus is further caused to:
cause, at least in part, the application to modify one or more dependency lists of dependent applications so as to change the one or more dependency linkages of any of the one or more other applications on the application.

57. An apparatus of claim 54, wherein the apparatus is further caused to:
cause, at least in part, provision of an option to promote at least one of the one or more other applications based on the one or more determined dependency linkages with the application.

58. An apparatus of claim 57, wherein the promotion is by way of a banner at the application store.

59. An apparatus of claim 55, wherein the apparatus is further caused to:
cause, at least in part, a determination of a customer base of the application; and
cause, at least in part, a direct promotion of at least one of the one or more other applications to the determined customer base of the application based, at least in part, on the determined dependency linkage.

60. An apparatus of claim 55, wherein the apparatus is further caused to:
cause, at least in part, at least one determination of cost information, revenue information, or a combination thereof for the one or more applications, the one or more other applications, or a combination thereof based, at least in part, on the one or more dependency linkages, the one or more respective dependency lists, or a combination thereof.

61. An apparatus of claim 55, wherein the apparatus is further caused to:
cause, at least in part, at least one determination of weighting information associated with the one or more applications, the one or more other applications, or a combination thereof based, at least in part, on the one or more dependency linkages, the one or more respective dependency lists, or a combination thereof; and
cause, at least in part, at least one determination of a revenue sharing plan among a first developer, at least one second developer, or a combination thereof based, at least in part, on the weighting information.

62. An apparatus of claim 61, wherein the revenue sharing plan is further based, at least in part, on one of (1) collected advertising revenue relating to the one or more applications, the one or more other applications, or a combination thereof; (2) a referral of the one or more applications, the one or more other applications, or a combination thereof; or (3) a combination thereof.

63. An apparatus of claim 62, wherein the referral is based, at least in part, on a promotion of at least one of the one or more applications, the one or more other applications, or a combination thereof in at least one of the one or more applications, the one or more other applications, or a combination thereof.

64. An apparatus of claim 63, wherein the apparatus is further caused to:
cause, at least in part, generation of a user interface configured to display the application store to one or more of a consumer and a developer based, at least in part, on log-in credentials,
wherein the log-in credentials enable access to the published configuration information, input parameters, output parameters and unique identifier for the application.

65. A method comprising:
determining one or more unique identifiers for one or more applications sold by way of one or more application stores;
causing, at least in part, an application of the one or more applications to publish, by way of the application store, one or more of configuration information, input parameters, output parameters and a unique identifier for the application;
causing, at least in part, one or more other applications to communicate with the application based on the unique identifier, configuration information and the input parameters for the application; and
causing, at least in part, a transmission of the output parameters to the one or more other applications.

66. A method of claim 65, further comprising:
causing, at least in part, at least one of the one or more other applications to send one or more determined dependency linkages between any of the one or more other applications and the application to the application.

67. A method of claim 66, further comprising:
causing, at least in part, the application to modify one or more dependency lists of dependent applications so as to change the one or more dependency linkages of any of the one or more other applications on the application.

68. A method of claim 66, further comprising:
causing, at least in part, provision of an option to promote at least one of the one or more other applications based on the one or more determined dependency linkages with the application.

69. A method of claim 68, wherein the promotion is by way of a banner at the application store.

70. A method of claim 66, further comprising:
causing, at least in part, a determination of a customer base of the application; and
causing, at least in part, a direct promotion of at least one of the one or more other applications to the determined customer base of the application based, at least in part, on the determined dependency linkage.

71. A method of claim 66, further comprising:
causing, at least in part, at least one determination of cost information, revenue information, or a combination thereof for the one or more applications, the one or more other applications, or a combination thereof based, at least in part, on the one or more dependency linkages, the one or more respective dependency lists, or a combination thereof.

72. A method of claim 66, further comprising:
causing, at least in part, at least one determination of weighting information associated with the one or more applications, the one or more other applications, or a combination thereof based, at least in part, on the one or more dependency linkages, the one or more respective dependency lists, or a combination thereof; and
causing, at least in part, at least one determination of a revenue sharing plan among a first developer, at least one second developer, or a combination thereof based, at least in part, on the weighting information.

73. A method of claim 72, wherein the revenue sharing plan is further based, at least in part, on one of (1) collected advertising revenue relating to the one or more applications, the one or more other applications, or a combination thereof; (2) a referral of the one or more applications, the one or more other applications, or a combination thereof; or (3) a combination thereof.

74. A non-transitory computer-readable storage medium carrying one or more sequences of one or more instructions which, when executed by one or more processors, cause an apparatus to perform at least:
determining one or more unique identifiers for one or more applications sold by way of one or more application stores;
causing, at least in part, an application of the one or more applications to publish, by way of the application store, one or more of configuration information, input parameters, output parameters and a unique identifier for the application;
causing, at least in part, one or more other applications to communicate with the application based on the unique identifier, configuration information and the input parameters for the application; and
causing, at least in part, a transmission of the output parameters to the one or more other applications.
